(19) United States
(12) Patent Application Publication
(10) Pub. No.: US 2026/0188903 A1
(43) Pub. Date: Jul. 2, 2026

(54) Bezel-Antenna Sharing for a Foldable Device

(71) Applicant: Google LLC, Mountain View, CA (US)

(72) Inventors: Zhenchao Yang, Bellevue, WA (US); Vijay L. Asrani, San Jose, CA (US); Pei Li, Milpitas, CA (US)

(73) Assignee: Google LLC, Mountain View, CA (US)

(21) Appl. No.: 19/040,392

(22) Filed: Jan. 29, 2025

Related U.S. Application Data
(60) Provisional application No. 63/740,627, filed on Dec. 31, 2024.

(51) Int. Cl. H01Q 7/00; H01Q 1/22; H04B 1/00

(52) U.S. Cl. CPC H01Q 7/00; H01Q 1/2208; H04B 1/0057

(57) ABSTRACT

Techniques associated with bezel-antenna sharing for a foldable device are described. To enhance a user experience with foldable devices and overcome unique challenges associated with wireless communication in foldable devices having two operating modes (e.g., closed mode and open mode), the techniques described herein integrate near-field communication (NFC) functionality with antenna detune elements, located on a bezel of a flip side of the foldable device, in a way that enables the NFC and radio frequency (RF) antennas to operate in both the closed and open modes. Integrating NFC with the bezel also reduces the overall thickness of the foldable device compared to conventional devices that use an NFC coil. In aspects, multiple detune elements on the bezel are bridged together to increase a length of an antenna used for NFC functions, without impacting performance of actively driven antennas (e.g., cellular, WiFi) on an opposing side of the foldable device.

### CROSS-REFERENCE TO RELATED APPLICATION(S)

This application claims the benefit of U.S. Provisional Patent Application Ser. No. 63/740,627 filed on Dec. 31, 2024, the disclosure of which is incorporated by reference herein in its entirety.

### BACKGROUND

Cellular smartphones have many wireless functions to support various use cases, including cellular (e.g., 3G/4G/5G), WiFi, Global Positioning System (GPS), ultrawide band (UWB), non-terrestrial network (NTN), and nearfield communication (NFC). Among those wireless functions, some devices use antennas that are separate from typical bezel antennas, including 5G mmWave, UWB Android Open Accessory (AoA), and NFC.

Conventional techniques for NFC antennas in foldable phones use an NFC coil, which occupies a relatively large area (e.g., 1000 square millimeters (mm²)) of the middle backside of the phone with approximately 0.2 mm thickness. Such architecture has a significant impact on the overall industrial design of a foldable phone, including up to 0.15 mm overall thickness in an open mode and 0.3 mm in a closed mode. The placement of the NFC coil can also limit the convenience of various critical use cases, including features such as NFC payments, tap to cast, and tap to share, which require the user to align the NFC coil in the middle backside of the phone to a reader. Due to the way users typically hold a smartphone (e.g., with their hand wrapped around the backside so as not to obscure the display on the front side), this placement of the NFC coil results in a poor user experience when attempting to use an NFC function.

Unlike the common “candy-bar” type smartphone (referred to as a “bar phone”), foldable smartphones have unique intrinsic challenges that prevent the use of conventional techniques for antenna sharing for NFC and radio frequency (RF) functions. One such challenge includes the ability for a shared NFC/RF antenna to work in both closed and open modes of the foldable phone. Another challenge is that the number and structural length of antennas at the top and bottom edges of a foldable phone are limited due to a hinge structure occupying one long edge of the foldable phone, preventing antennas from having a length sufficient to provide a good NFC coupling aperture. In addition, the top bezel antenna of the foldable phone, when used as an NFC antenna, can experience a drop in RF over-the-air (OTA) performance due to a high unwanted capacitive coupling to the hinge structure, which acts as a system ground. These and other challenges significantly impact the user experience.

### SUMMARY

Techniques associated with bezel-antenna sharing for a foldable device are described. To enhance a user experience with foldable devices and overcome unique challenges associated with wireless communication in foldable devices having two operating modes (e.g., closed mode and open mode), the techniques described herein integrate near-field communication (NFC) functionality with antenna detune elements, located on a bezel of a flip side of the foldable device, in a way that enables the NFC and RF antennas to operate in both the closed and open modes. Integrating NFC with the bezel also reduces the overall thickness of the foldable device compared to conventional devices that use an NFC coil. In aspects, multiple detune elements on the bezel are bridged together to increase a length of an antenna used for NFC functions, without impacting performance of actively driven antennas (e.g., cellular, WiFi) on the opposing side of the foldable device.

In one example, a foldable electronic device is disclosed. The foldable electronic device includes a housing, one or more displays, a plurality of antennas, a plurality of detune elements, and a near-field communication (NFC) loop. The housing has a first housing member and a second housing member connected together by a bendable region. In aspects, at least one of the first housing member or the second housing member is rotatable about the bendable region. Further, the first housing member has opposing first and second surfaces and the second housing member has opposing third and fourth surfaces. In implementations, the housing includes: an open mode in which the first and third surfaces are substantially coplanar and the bendable region is between the first and third surfaces; and a closed mode in which the housing is folded about the bendable region such that the first and third surfaces are substantially parallel to one another and located on a same side of the bendable region. The one or more displays are disposed on one or more of the first housing member or the second housing member. The plurality of antennas are integrated with a first bezel of the first housing member. The plurality of detune elements are integrated with a second bezel of the second housing member. In aspects, the plurality of detune elements are configured to detune the plurality of antennas when the housing is in the closed mode. The NFC loop is integrated with one or more detune elements of the plurality of detune elements on the second bezel of the second housing member.

In another example, a diplexer circuit for bezel-antenna sharing in a foldable electronic device is disclosed. The diplexer circuit includes a ground-loading structure, a first detune circuit, a semi-shorting structure, a second detune circuit, and a discreet inductor. The ground-loading structure is configured to load a first detune element of the foldable electronic device to electrical ground. In aspects, the first detune element is located on a bezel of a flip side of the foldable electronic device, where the flip side is connected to a base side of the foldable electronic device by a bendable region and the flip side is rotatable about the bendable region relative to the base side. The first detune circuit is connected to the first detune element. In aspects, the first detune circuit is configured to detune a first antenna located on the base side of the foldable electronic device when the foldable electronic device is folded in a closed mode. The semi-shorting structure electrically connects the first detune element to a second detune element of the foldable electronic device. In aspects, the semi-shorting structure is configured for appropriate loading at a first frequency band and have minimal impact at a second frequency band. In some examples, the second detune element is located on the flip side of the foldable electronic device. The second detune circuit has a series capacitor and is connected to the second detune element and is configured to detune a second antenna on the base side of the foldable electronic device when the foldable electronic device is folded in the closed mode. The discreet inductor is connected in parallel to the second detune circuit. In aspects, the discreet inductor is configured to isolate a feed matching network for the second frequency band from the second detune element.

This summary is provided to introduce simplified concepts of bezel-antenna sharing for a foldable device, which are further described below in the Detailed Description.

### BRIEF DESCRIPTION OF THE DRAWINGS

The details of one or more aspects of bezel-antenna sharing for a foldable device are described in this document with reference to the following drawings. The same numbers are used throughout the drawings to reference like features and components:

FIG. 1 illustrates an example environment in which aspects of bezel-antenna sharing for a foldable device can be implemented;

FIG. 2 illustrates an example of the foldable electronic device from FIG. 1, in accordance with one or more implementations;

FIG. 3 illustrates a rear view of an example implementation of the foldable electronic device from FIG. 1, in accordance with one or more implementations;

FIG. 4 illustrates an enlarged view of a portion of the foldable electronic device corresponding to section A-A in FIG. 3;

FIG. 5 illustrates an example diagram of a circuit that enables bezel-antenna sharing for a foldable device, in accordance with one or more implementations;

FIG. 6 illustrates an example implementation of a foldable device in a clamshell configuration that is configured for bezel-antenna sharing, in accordance with one or more implementations;

FIG. 7 illustrates an example wireless network device that can be implemented in accordance with one or more aspects of bezel-antenna sharing for a foldable device as described herein;

FIG. 8 illustrates an example system that includes an example device that implements aspects of bezel-antenna sharing for a foldable device as described with reference to the previous FIGS. 1 to 7.

### DETAILED DESCRIPTION

The techniques described herein provide bezel-antenna sharing for a foldable device. For example, NFC functionality is integrated into one or more detune elements on one side of a foldable phone (e.g., “flip” side), where the detune elements are configured to detune one or more RF antennas on the other side of the foldable phone (e.g., base side). Generally, the minimum requirement for a coupling coefficient to pass NFC card-mode performance and NFC reader-mode performance is 0.025. It is known that the length of a bezel has a direct impact on the coupling coefficient for near field coupling and maximal transmitting current. For example, a greater bezel length provides a higher coupling coefficient and higher transmitting power than a shorter bezel length. In foldable devices, however, the length of the detune elements is shorter due to limited spacing caused by the hinge in the middle of the foldable device being a grounding structure. As described herein, in some examples, two or more detune elements are bridged together to increase an NFC loop size (e.g., length) and consequently increase the coupling coefficient.

In another example, a diplexer circuit is implemented to diplex different frequency bands (e.g., NFC and RF signals), such as when the foldable phone is in the closed mode, resulting in proximity between actively driven antennas (e.g., cellular) and the detune elements integrated with NFC functionality. Diplexer circuits typically use series inductors to isolate the different signals. In one example, a diplexer circuit uses series inductor(s) to block RF signals and uses series capacitor(s) to block NFC signals. These series inductors, however, have a high impact on the coupling coefficient for near field coupling, maximal transmitting current, and NFC matching efficiency. For example, a higher total inductance of the diplexer results in a lower coupling coefficient, a lower NFC matching network efficiency, and a lower transmitting current. Further, parasitic resistance of the series inductors can lead to self-heating of the inductors and power loss.

To increase or maximize the coupling coefficient, the diplexer circuit described herein includes a total inductance of, for example, 50 nanohenry (nH) or less. To reduce or minimize power loss, the diplexer circuit includes total resistive parasitics of, for example, 1.0 Ohm or less (e.g., between zero and 1.0 Ohm). Further, the diplexer circuit supports an NFC high current.

Bridging the two or more detune elements on the flip side of the foldable phone can enhance Long Term Evolution (LTE) signals, WiFi signals, and Bluetooth™ (BT) signals while also reducing negative impacts to global navigation satellite system (GNSS), NTN, and satellite communications in the closed mode. In some examples, an NFC grounding port for the NFC function of the detune element has a zero Ohm loading, which can be implemented as a physical shorting structure. These techniques can also be implemented at the bottom edge of the foldable phone to enable dual NFC (e.g., user can scan from either of the top or bottom edges of the foldable phone). As described herein, the “top” of the device refers to the top of the device with respect to a user perspective when the user is holding the device in a portrait orientation.

While features and concepts of the described techniques for bezel-antenna sharing for a foldable device can be implemented in any number of different environments, aspects are described in the context of the following examples.

### EXAMPLE ENVIRONMENT

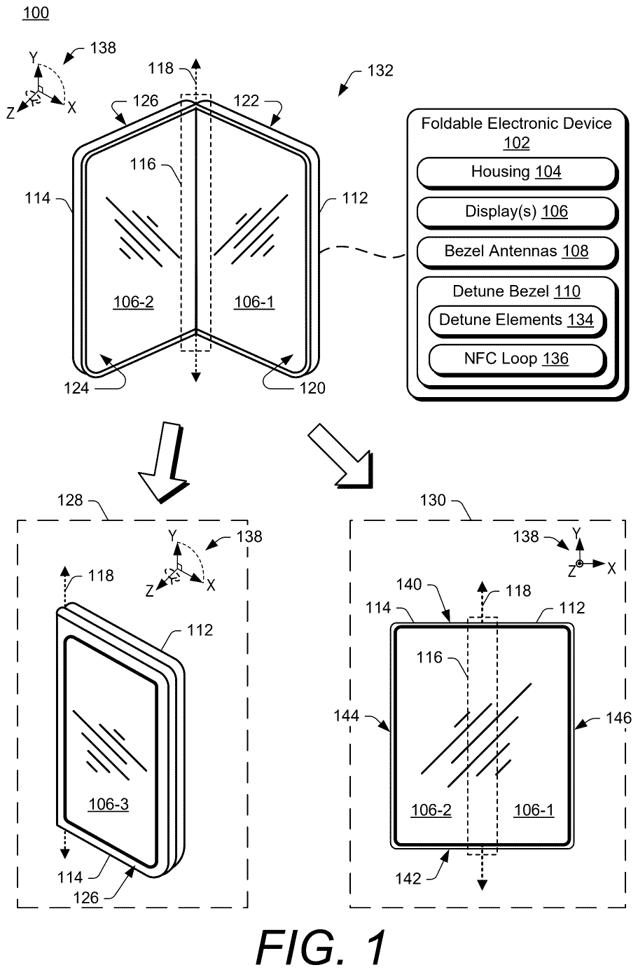

FIG. 1 illustrates an example environment 100 in which bezel-antenna sharing for a foldable device can be implemented. The example environment 100 includes a foldable electronic device 102, which includes a housing 104, one or more displays 106, one or more bezel antennas 108, and one or more detune bezels 110.

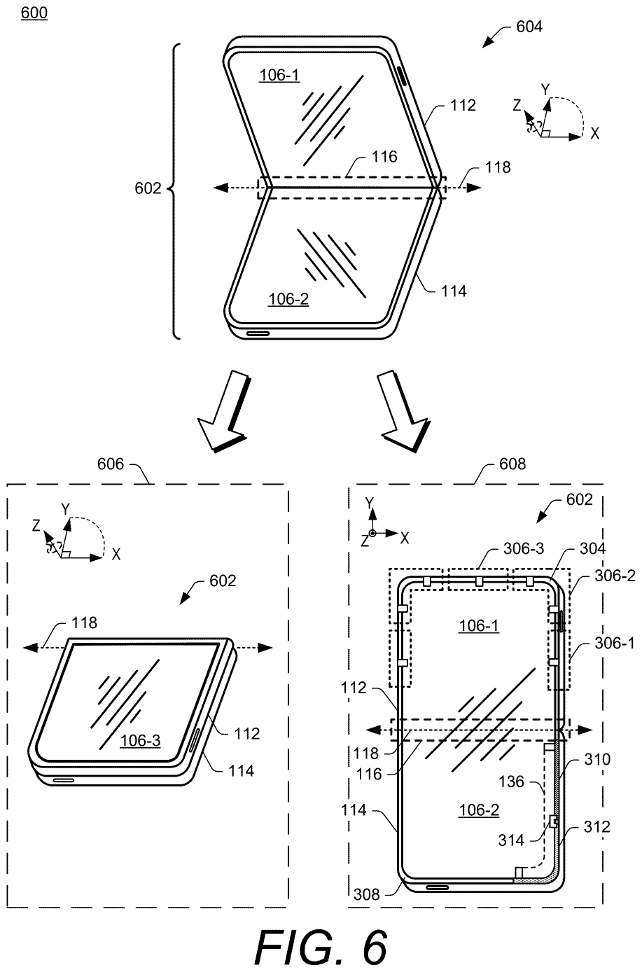

The housing 104 includes a first housing member 112 and a second housing member 114 connected together by a bendable region 116. In one example, the first housing member 112 is a base side of the foldable electronic device 102 and the second housing member 114 is a flip side of the foldable electronic device 102. In another example, the first housing member 112 is the flip side and the second housing member 114 is the base side. The flip side can rotate about the bendable region 116 (e.g., axis 118) relative to the base side. In one example, the bendable region 116 corresponds to a y-axis, as illustrated in FIG. 1. In another example, the bendable region 116 corresponds to an x-axis, as illustrated in and described with respect to FIG. 6.

In addition, the flip side and the base side each include a respective front surface and a respective opposing rear surface. For example, the first housing member 112 includes a first front surface 120 and a first rear surface 122. In addition, the second housing member 114 includes a second front surface 124 and a second rear surface 126.

The one or more displays 106 can include any suitable number of display devices. In the illustrated example, the one or more displays 106 include a first display 106-1, a second display 106-2, and a third display 106-3. In some implementations, the base side includes a display on its front side and one or more rear-facing cameras on its rear side, while the flip side includes displays on both its front and rear sides. In the illustrated example, the first housing member 112 includes the first display 106-1 on the first front surface 120 and one or more rear-facing cameras (not shown for clarity) on the first rear surface 122, while the second housing member 114 includes the second display 106-2 on the second front surface 124 and the third display 106-3 on the second rear surface 126.

By rotating about the bendable region 116, the housing 104 can be mechanically oriented into one or more configurations or mechanical modes. For example, the housing 104 can be folded to a closed mode 128, an open mode 130, or a partially open mode 132. The closed mode 128 includes the first front surface 120 of the first housing member 112 in close proximity to the second front surface 124 of the second housing member 114. In this way, the housing 104 is like a closed book, with the two housing members (e.g., the first and second housing members 112 and 114) brought together in close proximity, such that an angle formed between the first front surface 120 and the second front surface 124 is substantially 0°. The open mode 130 is like an open book and includes the first housing member 112 being substantially aligned with the second housing member 114, such that the first display 106-1 is located side-by-side and substantially coplanar with the second display 106-2. In aspects, an angle formed between the first front surface 120 and the second front surface 124 in the open mode 130 is substantially 180°. In some implementations, the first display 106-1 and the second display 106-2 form a single, wide display in the open mode 130. Accordingly, the first display 106-1 and the second display 106-2 can collectively be referred to as a larger display in comparison to the third display 106-3, which is a smaller display. Between the open mode 130 and the closed mode 128 is the partially open mode 132 in which the foldable electronic device 102 is like a partially open book. For example, an angle formed between the first front surface 120 and the second front surface 124 in the partially open mode 132 is between 0°and 180°.

The bezel antennas 108 include any suitable antenna formed using the edges of a frame of the housing 104. For example, the bezel antennas 108 can be formed using portions of the frame of the housing 104. Some examples of bezel antennas 108 include antennas configured to support signal transmission and reception for cellular, WiFi, Global Positioning System (GPS), Bluetooth™, ultrawide band (UWB), non-terrestrial network (NTN), and nearfield communication (NFC).

The detune bezel 110 includes detune elements 134 and an NFC loop 136. The detune bezel 110 is typically located opposite a bezel having the bezel antennas 108. For example, if the base side includes the bezel antennas 108, then the flip side includes the detune bezel 110, such that in the closed mode 128, the detune elements 134 are brought in close proximity to one or more of the bezel antennas 108 and cause detuning to the one or more bezel antennas 108. While in the open mode 130, however, the detune bezel 110 is distal from the bezel antennas 108 and physically separated by the bendable region 116. In the open mode 130, the detune elements 134 cause little to no detuning to the bezel antennas 108.

In aspects, the NFC loop 136 is integrated with one or more of the detune elements 134. In this way, one or more of the detune elements 134 are used to provide NFC functionality. In some implementations, two or more of the detune elements 134 are bridged together to increase a size (e.g., length) of the NFC loop 136. Further, circuitry is implemented to diplex signals, such as NFC signals and RF signals.

For clarity, the foldable electronic device 102 and associated features are described herein relative to a coordinate system 138 having an x-axis, a y-axis, and a z-axis. In aspects, the housing 104 of the foldable electronic device 102 includes a length along the y-axis, a width along the x-axis, and a depth along the z-axis. In some aspects, the length is greater than the width and the width is greater than the depth in the open mode and/or the closed mode. In some examples, the width is greater than the length and the length is greater than the depth in the open mode and/or the closed mode. In one example, the length and width are substantially equal in the open mode. In another example, the length and width are substantially equal in the closed mode.

Accordingly, directional references to particular sides or surfaces of the foldable electronic device 102 are described relative to the coordinate system 138, including a front, a rear, left and right sides, a top, and a bottom of the foldable electronic device 102. In one example, the top of the foldable electronic device 102 is based on how a user would hold, view, and interact with the device 102 when the device 102 is in a portrait orientation. In the illustrated example, the foldable electronic device 102 includes a top edge 140 and a bottom edge 142 that are substantially parallel to one another and each intersect the y-axis (which can include the bendable region 116). The front side of the foldable electronic device 102, as described herein, is shown by the illustration of the open mode 130 in FIG. 1 and includes a display device across both the first and second housing members 112 and 114. Relative to the coordinate system 138, the foldable electronic device 102 includes a left edge 144 and a right edge 146, which are distal from the bendable region 116 such that the left and right edges 144 and 146, respectively, are on opposing sides of the bendable region 116 in the open mode 130 but on the same side of the bendable region 116 in the closed mode 128.

The foldable electronic device 102 in FIG. 1 is described as having the bendable region 116 corresponding to the y-axis (e.g., axis 118), such that the foldable electronic device 102 is in a “booklet-style” configuration where the device 102 has a bar-phone form in the closed mode 128 and opens into a wider, tablet-like form in the open mode 130. In the closed mode 128, for instance, the bendable region 116 can be on the long edge of the housing 104. In one example, the larger display (e.g., the first and second displays 106-1 and 106-2) wraps around to the back of the device 102 when folded into the closed mode 128. In another example, the larger display (e.g., the first and second displays 106-1 and 106-2) is folded to the interior of the closed mode 128 and the smaller display (e.g., the third display 106-3) is located on the device's “cover” to enable the user to interact with the device 102 without opening the device 102.

In some implementations, the bendable region 116 corresponds to the x-axis, forming a “clamshell” configuration (e.g., “flip phone”) in which the bendable region 116 is on the short edge of the housing 104 in the open mode 130. An example clamshell configuration is described with respect to FIG. 6. In the clamshell configuration, the foldable electronic device 102 has a substantial bar-phone form in the open mode 130 and clamshell-like form in the closed mode 128. In one example, the larger display (e.g., the first and second displays 106-1 and 106-2) can wrap around to the back of the device 102 when folded into the closed mode 128. In another example, the larger display (e.g., the first and second displays 106-1 and 106-2) is folded to the interior of the closed mode 128 and the smaller display (e.g., the third display 106-3) is located on the device's “cover” to enable the user to interact with the device 102 without opening the device 102.

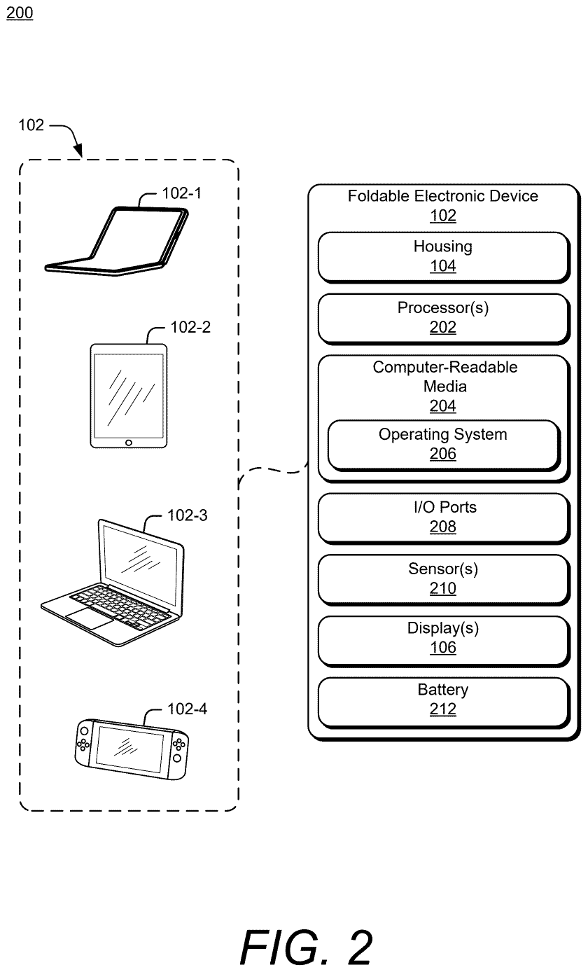

FIG. 2 illustrates an example of the foldable electronic device 102 from FIG. 1, in accordance with one or more implementations. The foldable electronic device 102 can include additional components and interfaces omitted from FIG. 2 for the sake of clarity.

The foldable electronic device 102 can be any of a variety of consumer electronic devices. As non-limiting examples, the foldable electronic device 102 can be a foldable smartphone 102-1, a foldable tablet device 102-2, a foldable laptop computer 102-3, a foldable portable video game console 102-4, and the like, or any foldable electronic device that integrates NFC into the detune bezel.

The foldable electronic device 102 includes a housing (e.g., the housing 104), which defines at least two housing members connected together by a bendable region, such as a hinge, which enables one housing member to rotate about the bendable region relative to the other housing member. In implementations, a mechanical frame can define one or more portions of the housing 104. As an example, a mechanical frame can include plastic or metallic walls that define portions of the housing 104. In additional implementations, a mechanical frame can support one or more portions of the housing 104. As an example, one or more exterior housing components (e.g., plastic panels) can be attached to the mechanical frame (e.g., a chassis). In so doing, the mechanical frame physically supports the one or more exterior housing components, which define portions of the housing 104. In some implementations, the mechanical frame and/or the exterior housing components are composed of crystalline or non-crystalline solids. In some examples, the mechanical frame supports or includes one or more bezels along a perimeter of the mechanical frame. The bezels are usable to support antenna functionality.

The foldable electronic device 102 can further include one or more processors 202. The processors(s) 202 can include, as non-limiting examples, a system on a chip (SoC), an application processor (AP), a central processing unit (CPU), or a graphics processing unit (GPU). The processors(s) 202 generally execute commands and processes utilized by the foldable electronic device 102 and an operating system installed thereon. For example, the processors(s) 202 can perform operations to display graphics of the foldable electronic device 102 on the one or more displays 106 and can perform other specific computational tasks.

The foldable electronic device 102 can also include computer-readable storage media (CRM) 204. The CRM 204 may be a suitable storage device configured to store device data of the foldable electronic device 102, user data, and multimedia data. The CRM 204 can store an operating system 206 that generally manages hardware and software resources (e.g., the applications) of the foldable electronic device 102 and provides common services for applications stored on the CRM 204. The operating system 206 and the applications are generally executable by the processors(s) 202 to enable communications and user interaction with the foldable electronic device 102. One or more processors(s) 202, such as a GPU, perform operations to display graphics of the foldable electronic device 102 on the one or more displays 106 and can perform other specific computational tasks. The processors(s) 202 can be single-core or multiple-core processors.

The foldable electronic device 102 can also include input/output (I/O) ports 208 The I/O ports 208 allow the foldable electronic device 102 to interact with other devices or users. The I/O ports 208 may include any combination of internal or external ports, such as universal serial bus (USB) ports, audio ports, Serial Advanced Technology Attachment (SATA) ports, peripheral component interconnect express (PCI-express) based ports or card-slots, secure digital input/output (SDIO) slots, and/or other legacy ports.

The foldable electronic device 102 can further include one or more sensors 210 The sensor(s) 210 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), an under-display fingerprint sensor, or an ambient light sensor (e.g., photodetector). In implementations, the foldable electronic device 102 includes one or more front-facing sensors and/or one or more rear-facing sensors.

Further, the foldable electronic device 102 includes the one or more displays 106 (e.g., a foldable display). In some examples, the displays 106 have one or more cover layers and one or more display panels. The cover layer(s) can be implemented as any of a variety of transparent materials including polymers (e.g., plastic, acrylic) or glasses. The cover layer(s) may form any foldable, three-dimensional shape.

The foldable electronic device 102 further includes a battery 212. In implementations, the battery 212 is a rechargeable battery that is configured to store and supply electrical energy. The rechargeable battery may be any suitable rechargeable battery, such as a lithium-ion (Li-ion) battery.

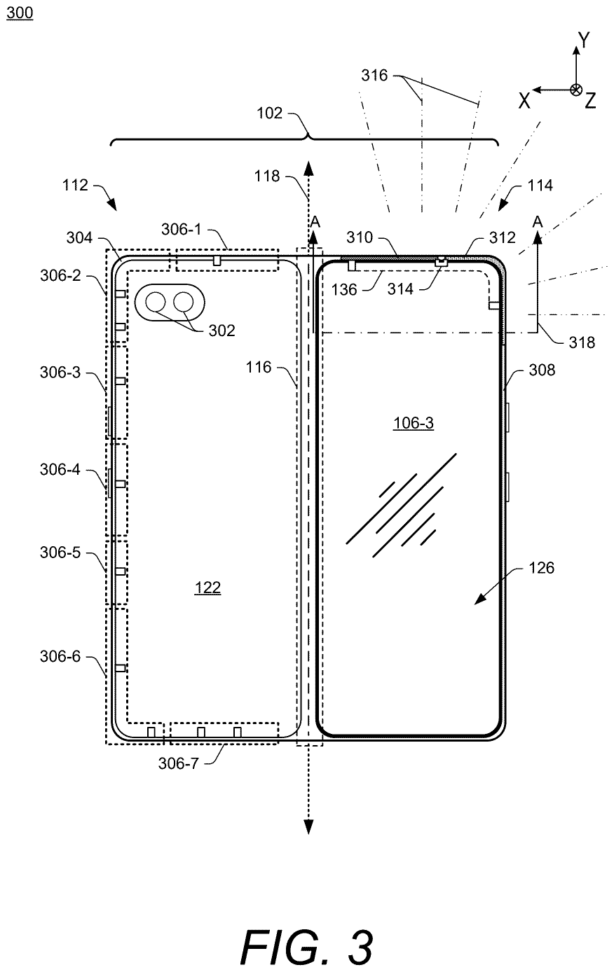

FIG. 3 illustrates a rear view 300 of an example implementation of the foldable electronic device 102 from FIG. 1, in accordance with one or more implementations. In the illustrated example, the foldable electronic device 102 is in the open mode 130 (from FIG. 1) and the rear view 300 shows the backside of the foldable electronic device 102, including the first rear surface 122 of the first housing member 112 and the second rear surface 126 of the second housing member 114. In the example shown in FIG. 3, the first housing member 112 includes one or more cameras 302 on the first rear surface 122 and the second housing member 114 includes the third display 106-3 on the second rear surface 126. In some implementations, the first housing member 112 can include a display on the first rear surface 122 and the second housing member 114 can include one or more cameras 302. In another implementation, the first rear surface 122 and the second rear surface 126 can each include a display device. In one example, the first and second rear surfaces 122 and 126 can include individual displays. In another example, a bendable display can extend across both of the first and second rear surfaces 122 and 126.

The first housing member 112 includes a first bezel 304 and a plurality of antennas 306 implemented in the first bezel 304. For example, the first bezel 304 includes a first antenna 306-1, a second antenna 306-2, a third antenna 306-3, a fourth antenna 306-4, a fifth antenna 306-5, a sixth antenna 306-6, and a seventh antenna 306-7. However, any suitable number of antennas 306 can be implemented along the first bezel 304 of the first housing member 112 to enable wireless communication using various frequency bands. Unlike a conventional bar phone that can include antennas all the way around its edges, doing so on the foldable electronic device 102 would result in antennas on opposing edges interfering with (e.g., detuning) one another when they are brought into close proximity in the closed mode 128 (from FIG. 1). This can be particularly challenging for some RF antennas, such as cellular and WiFi antennas.

The second housing member 114 includes a second bezel 308 having one or more detune elements (e.g., the detune elements 134) used to reduce or negate the effects to RF frequencies caused by the proximity of the second housing member 114 to the first housing member 112, with respect to the antennas 306 that are implemented as, for example, cellular antennas, WiFi antennas, etc. The second bezel 308 is an example of the detune bezel 110. In the illustrated example, the second housing member 114 includes a first detune element 310 and a second detune element 312. The bendable region 116 (e.g., hinge) acts as an electrical ground. The first detune element 310 is configured to detune the first antenna 306-1. The second detune element 312 is configured to detune the second antenna 306-2. Additional detune elements (not shown for clarity) can be implemented on the second bezel 308 to detune each of the other antennas 306 on the first bezel 304 (e.g., the third antenna 306-3 through the seventh antenna 306-7).

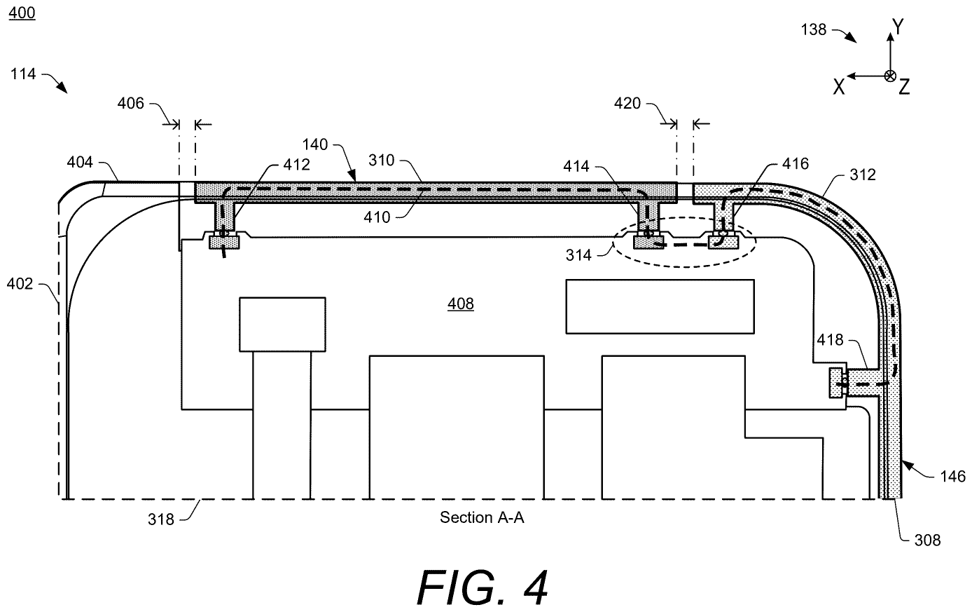

In the foldable electronic device 102, NFC functionality can be integrated with one or more of the detune elements 134. In some implementations, a single detune element (e.g., the first detune element 310) provides narrow coverage for NFC signals due to the length of the detune element limiting the size of an NFC loop (e.g., NFC loop 136). To enlarge the coverage of the NFC signals, two or more detune elements can be combined together to increase the size of the NFC loop 136. For example, the first detune element 310 and the second detune element 312 can be combined together by a bridge 314 to form a single NFC loop. The bridge 314 enables electric current (e.g., direct current) to pass through both the first detune element 310 and the second detune element 312. In this way, the NFC functionality is integrated into the detune elements, but not the antenna itself (e.g., antennas 306). This also provides wider coverage for the NFC functionality (e.g., NFC signals 316) at the top of the device 102, which enhances the user experience by increasing the convenience of using the NFC functionality (e.g., using NFC payments, tap to cast, tap to share, etc. while holding the middle of the device 102). A portion 318 corresponding to section A-A is described in more detail in FIG. 4.

FIG. 4 illustrates an enlarged view 400 of the portion 318 of the foldable electronic device corresponding to section A-A in FIG. 3. In FIG. 4, the second housing member 114 includes multiple detune elements 134, including the first detune element 310 and the second detune element 312. The first detune element 310, in this example, extends along a portion of the top edge 140 of the second housing member 114. The second detune element 312 extends from the top edge 140 to the right edge 146 of the foldable electronic device 102, which is the edge of the second housing member 114 that is opposite the bendable region 116 (e.g., hinge 402). The hinge 402 is represented by a dashed line in FIG. 4, although the hinge 402 can be any suitable width.

The hinge 402 acts as an electrical ground. Starting from the hinge 402 on the left of the illustration, a first portion 404 of the second bezel 308 (e.g., the detune bezel 110) on the top edge 140 is grounded. The first detune element 310 is separated from the first portion 404 by a first gap 406. The first detune element 310 is physically and electrically coupled to a printed circuit board (PCB) 408 at multiple locations, to enable electrical current 410 to pass through the first detune element 310. For example, the first detune element 310 is connected to the PCB 408 via a first leg 412 and a second leg 414, both of which extend from the first detune element 310 to the PCB 408. The first and second legs 412 and 414, respectively, can be connected to the PCB 408 via surface-mount technology (SMT) springs or any other suitable mounting technique.

The second detune element 312 is also physically and electrically coupled to the PCB 408 at multiple locations. For example, the second detune element 312 is connected to the PCB 408 via a third leg 416 and a fourth leg 418, both of which extend from the second detune element 312 to the PCB 408. The third and fourth legs 416 and 418, respectively, can be connected to the PCB 408 via SMT springs or any other suitable mounting technique. The second detune element 312 is separated from the first detune element 310 by a second gap 420.

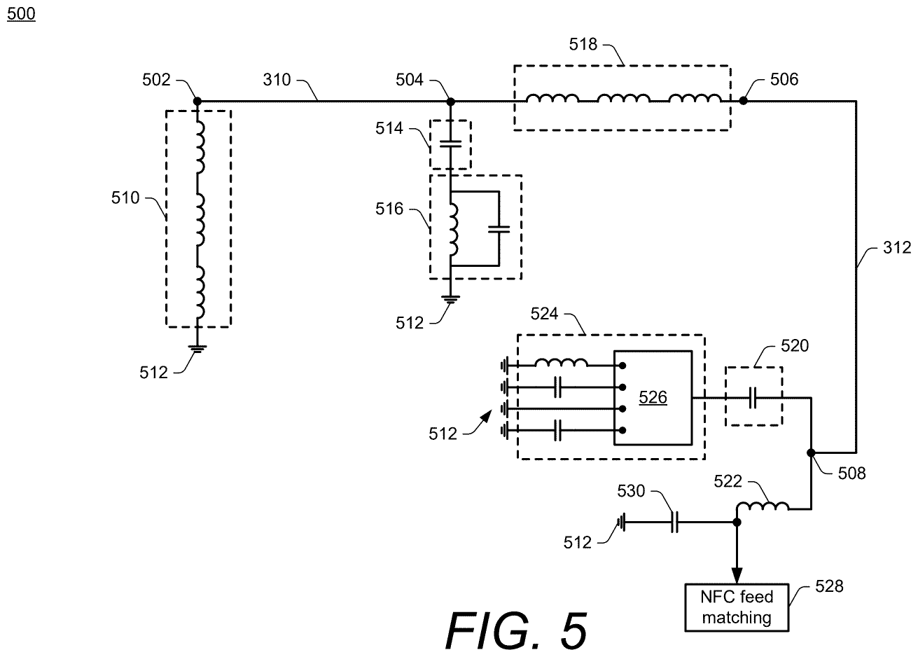

In implementations, the first detune element 310 and the second detune element 312 are combined together by the bridge 314, which provides a greater length for an integrated NFC loop (e.g., the NFC loop 136 in FIG. 3). As is described in further detail with respect to FIG. 5, the second and third legs 414 and 416, respectively, are not grounded but are connected to the PCB 408 for structural purposes. In other words, the second and third legs 414 and 416 are electrically connected to a non-grounding portion of the PCB 408 based on, for example, SMT springs. In implementations, the second and third legs 414 and 416, respectively, are configured for appropriate loading for some frequencies but have minimal impact at NFC frequencies. In this way, the bridge 314 enables extension of the NFC loop without interfering with other RF frequencies, such as cellular, WiFi, GNSS, NTN, UWB, etc.

In an example, the first leg 412 acts as a first port (e.g., Port0) and NFC ground, the second leg 414 acts as a second port (e.g., Port1), the third leg 416 acts as a third port (e.g., Port2), and the fourth leg 418 acts as a fourth port (e.g., Port3) and NFC feed. In aspects, the first port can be referred to as an NFC-grounding port and the fourth port can be referred to as an NFC-feed port. The electrical current 410 provided via the NFC-feed port passes through both detune elements via the bridge 314, resulting in an NFC loop having sufficient length to provide wider coverage for NFC communication.

FIG. 5 illustrates an example diagram of a circuit 500 that enables bezel-antenna sharing for a foldable device, in accordance with one or more implementations described herein. The foldable device can be any suitable foldable device, such as the foldable electronic device 102 in FIG. 1. An NFC loop can be integrated with the detune element(s), if the NFC loop and the detune element each have their own matching circuit. In aspects, the circuit 500 is a diplexer circuit, which is configured to diplex (e.g., separate) at least two signal types, such as different frequency bands. Further, the circuit 500 reduces (including minimizes) the number of diplexing inductors included in the circuit 500 for reduced (including minimized) loss in the NFC path. The circuit 500 includes an example of two detune elements (e.g., the first and second detune elements 310 and 312) being bridged together to provide an NFC loop that shares the two detune elements with the function of the bezel antennas (e.g., bezel antennas 108 in FIG. 1). Any suitable number of detune elements can be combined.

In the illustrated example, the circuit 500 includes multiple ports, including a first port 502 (Port0), a second port 504 (Port1), a third port 506 (Port2), and a fourth port 508 (Port3). The first port 502 corresponds to the first leg 412 of the first detune element 310 shown in FIG. 4. The second port 504 corresponds to the second leg 414 of the first detune element 310 shown in FIG. 4. The third port 506 corresponds to the third leg 416 of the second detune element 312 shown in FIG. 4. The fourth port 508 corresponds to the fourth leg 418 of the second detune element 312 shown in FIG. 4.

The circuit 500 includes a ground-loading structure 510 connecting the first detune element 310 at the first port 502 in series with an electrical ground 512 (e.g., NFC ground). In an example, the ground-loading structure 510 includes a low-pass filter with one or more zero Ohm (0Ω) resistors. In another example, the ground-loading structure 510 includes one or more inductors having an inductance of approximately 9.9 nH. In another example, the ground-loading structure 510 includes a physical shorting structure, such as a physical connection between the first detune element 310 and a chassis or a frame of the foldable electronic device 102.

At the second port 504, which is proximate to the opposing end of the first detune element 310 from the first port 502, is a first high-pass filter 514 and a first detune circuit 516. The first high-pass filter 514 in FIG. 5 includes a capacitor, which can have any suitable total capacitance (e.g., 100 picofarad (pF), 150 pF, 200 pF, 500 pF). However, the first high-pass filter 514 can be any suitable high-pass filter, including one or more capacitors, inductors, and/or resistors. The first detune circuit 516 is series connected to the first high-pass filter 514 and electrical ground 512. The first detune circuit 516 can include any suitable detuning circuit, such as one or more inductor-capacitor (LC) circuits (e.g., resonant circuits). As known in the industry, an LC circuit includes at least one inductor L and at least one capacitor C connected together. The first detune circuit 516 is configured to use the first detune element 310 to detune a first antenna (e.g., the first antenna 306-1 shown in FIG. 3) on the base side of the foldable electronic device 102. In an example, the first detune circuit 516 includes an inductance of 0Ω. In another example, the first detune circuit 516 includes a band pass filter and an LC circuit (e.g., resonant circuit) for resonant loading. The band pass filter can short out-of-band signals to the electrical ground 512 and only pass a band of interest with a different loading condition (e.g., based on the inductor/capacitor combination in the LC circuit) from the LC circuit of the first detune circuit 516.

The circuit 500 also includes a semi-shorting structure 518 bridging the first detune element 310 with the second detune element 312. For example, the semi-shorting structure 518 connects the second port 504 in series with the third port 506. As mentioned in FIG. 4, the second port 504 corresponds to the second leg 414 (shown in FIG. 4), which extends from the first detune element 310 to the PCB 408 (shown in FIG. 4), and the third port 506 corresponds to the third leg 416 (shown in FIG. 4), which extends from the second detune element 312 to the PCB 408. Accordingly, the semi-shorting structure 518 can be implemented on the PCB 408 without being grounded. In aspects, the semi-shorting structure 518 is configured to properly load with respect to a first frequency band (e.g., cellular, WiFi) but have minimal impact with respect to a second frequency band (e.g., NFC frequencies). In this way, the semi-shorting structure 518 is semi-short but not fully short. In an example, the semi-shorting structure 518 includes one or more inductors to meet an NFC requirement with low loss and a high self-resonance frequency and a high current. In the illustrated example, the semi-shorting structure 518 includes three inductors, which include two zero Ohm resistors and one inductor having an inductance of 20 nanohenry (nH) or less, including 2.2 nH, 5 nH, 7 nH, 9.2 nH, etc. In practice, the semi-shorting structure 518 can include a single discreet inductor.

The fourth port 508, at the opposing end of the second detune element 312 from the third port 506, connects to a second high-pass filter 520 and a discreet inductor 522. The second high-pass filter 520 is series connected between the fourth port 508 and a second detune circuit 524. The second high-pass filter 520 in FIG. 5 includes a capacitor, which can have any suitable total capacitance (e.g., 100 pF, 150 pF, 200 pF, 500 pF). However, the second high-pass filter 520 can be any suitable high-pass filter, including one or more capacitors, inductors, and/or resistors.

The second detune circuit 524 is series connected to the second high-pass filter 520 and electrical ground 512. The second detune circuit 524 is configured to use the second detune element 312 to detune a second antenna (e.g., the second antenna 306-2 shown in FIG. 3) on the base side of the foldable electronic device 102. In an example, the second detune circuit 524 includes a switch 526, such as a pin diode switch or RF switch, which routes a high-frequency signal (filtered by the second high-pass filter 520) through a set of transmission paths. Any suitable switch can be implemented, including a switch providing one RF input and four RF outputs. In another example, the second detune circuit 524 includes a band pass filter and an LC circuit (e.g., resonant circuit) for resonant loading. The band pass filter can short out-of-band signals to the electrical ground 512 and only pass a band of interest with a different loading condition (e.g., based on the LC combination) from the LC circuit of the second detune circuit 524.

The discreet inductor 522 can be any suitable inductor. In an example, the discreet inductor 522 has an inductance of less than 100 nH, less than 50 nH, or less than 20 nH, such as 17 nH. The discreet inductor 522 is parallel connected to the second high-pass filter 520 and the second detune circuit 524. In aspects, the discreet inductor 522 is part of a detune aperture loading selection in that the discreet inductor 522 not only diplexes but also facilitates antenna matching.

For example, the discreet inductor 522 feeds into an NFC feed matching network 528, which is configured for antenna matching in the NFC frequencies. The discreet inductor 522 is configured to isolate the feed matching network 528 for an NFC frequency band from the second detune element 312. The NFC feed matching network 528 is parallel to a capacitor 530 connected to electrical ground 512. The capacitor 530 can be any suitable capacitor or set of capacitors. In an example, the capacitor 530 has a total capacitance of less than 600 pF, including 560 pF.

The circuit 500 reduces the number of diplexing inductors and reduces loss in the NFC path, compared to conventional techniques. Further, implementing the circuit 500 enhances performance of the first antenna 306-1 (shown in FIG. 3) in the closed mode 128 in comparison to conventional foldable devices. In an example, using the techniques described herein, 5G antenna efficiency of the first antenna 306-1 in the closed mode 128 increased in low band frequencies (e.g., 0.6 gigahertz (GHz) to 1.0 GHz) by about 1.5 decibels (dB), increased in medium band frequencies (e.g., 1.7 GHz to 2.2 GHz) by up to 3 dB, increased in high band frequencies (e.g., 2.3 GHz to 2.7 GHz) by up to 1 dB, and did not affect ultra-high band (UHB) frequencies (e.g., 3.3 GHz to 4.2 GHz)

The circuit 500 includes a total inductance below a first threshold value. The total inductance is determined by a combination of the ground-loading structure 510, the semi-shorting structure 518, and the discreet inductor 522. In an example, the first threshold value is approximately 20 nH. In addition, to reduce or minimize power loss, parasitic resistance of the circuit 500 are controlled and maintained below a second threshold value. In an example, the second threshold value is approximately 1.0 Ohm.

FIG. 6 illustrates an example implementation 600 of a foldable device 602 in a clamshell configuration that is configured for bezel-antenna sharing, in accordance with one or more implementations. The foldable device 602 is an example of the foldable electronic device 102 in FIG. 1. In FIG. 6, the foldable electronic device 102 is illustrated with a partially open mode 604, a closed mode 606, and an open mode 608. In the clamshell configuration, the bendable region 116 is located along the x-axis, or the short axis of the housing 104 when in the open mode 604. The first and second displays 106-1 and 106-2 can collectively form a large display relative to the third display 106-3, which forms a small display on the opposite surface of the flip side of the housing 104 (e.g., the first housing member 112 or the second housing member 114). The large display can be folded to the interior of the housing 104 in the closed mode 606. Alternatively, in some implementations, the large display is wrapped around the back side of the device 102 such that the first and second displays 106-1 and 106-2 are on opposing exterior surfaces of the device 102 in the closed mode 606.

Similar to the booklet-style configuration described in FIG. 3, bezel-antenna sharing can also be implemented in the clamshell configuration. The first housing member 112 includes a plurality of antennas 306 implemented along the first bezel 304. For example, the first housing member 112 includes a first antenna 306-1, a second antenna 306-2, a third antenna 306-3, and a fourth antenna 306-4 implemented along the first bezel 304. The second housing member 114 includes one or more detune elements (e.g., the first detune element 310 and the second detune element 312) implemented along the second bezel 308. The bendable region 116 (e.g., hinge) acts as electrical ground. Each of the detune elements is configured to detune one or more of the antennas 306 when the housing 104 is in the closed mode 606. NFC functionality is integrated into one or more of the detune elements. In some aspects, two or more detune elements are combined together (e.g., by the bridge 314) to increase the size of the NFC loop 136. Accordingly, the techniques described with respect to FIGS. 1-5 can be implemented in the foldable electronic device 102 having the clamshell configuration shown in FIG. 6 to provide bezel-antenna sharing.

### EXAMPLE ENVIRONMENTS AND DEVICES

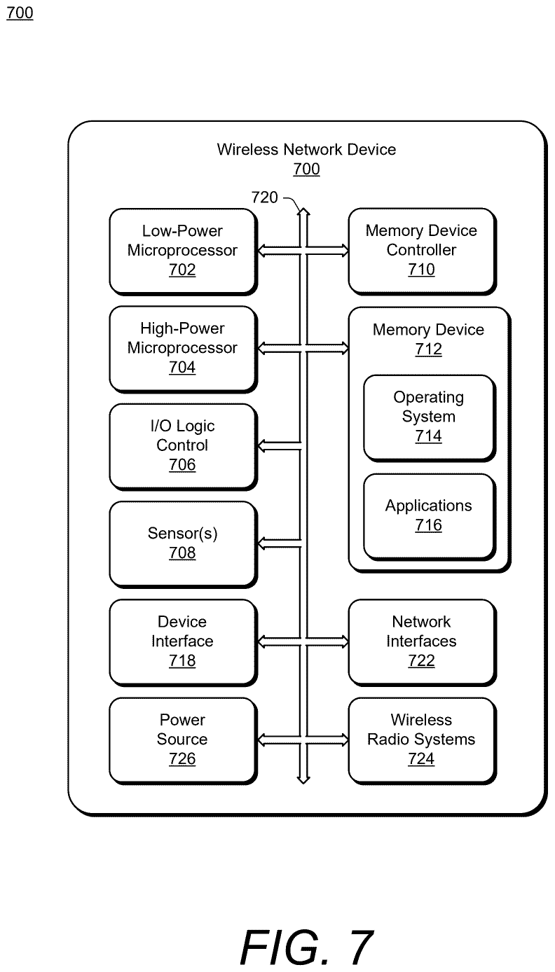

FIG. 7 illustrates an example wireless network device 700 (e.g., the foldable electronic device 102) that can be implemented in accordance with one or more aspects of bezel-antenna sharing for a foldable device as described herein. The device 700 can be integrated with electronic circuitry, microprocessors, memory, input/output (I/O) logic control, communication interfaces and components, and other hardware, firmware, and/or software to implement the device 700 in a home area network. Further, the wireless network device 700 can be implemented with various components, such as with any number and combination of different components as further described with reference to the example device shown in FIG. 7.

In this example, the wireless network device 700 includes a low-power microprocessor 702 and a high-power microprocessor 704 (e.g., microcontrollers or digital signal processors) that process executable instructions. The device 700 also includes an input-output (I/O) logic control 706 (e.g., to include electronic circuitry). The microprocessors can include components of an integrated circuit, a programmable logic device, a logic device formed using one or more semiconductors, and other implementations in silicon and/or hardware, such as a processor and memory system implemented as a system-on-chip (SoC). Alternatively or in addition, the device 700 can be implemented with any one or combination of software, hardware, firmware, or fixed logic circuitry that may be implemented with processing and control circuits. The low-power microprocessor 702 and the high-power microprocessor 704 can also support one or more different device functionalities of the device 700. For example, the high-power microprocessor 704 may execute computationally intensive operations, whereas the low-power microprocessor 702 may manage less complex processes such as detecting a hazard or temperature from one or more sensors 708. The low-power microprocessor 702 may also wake or initialize the high-power microprocessor 704 for computationally intensive processes.

The one or more sensors 708 can be implemented to detect various properties such as acceleration, temperature, humidity, water, supplied power, proximity, external motion, device motion, sound signals, ultrasound signals, light signals, fire, smoke, carbon monoxide, GPS signals, radio frequency (RF), other electromagnetic signals or fields, or the like. As such, the sensors 708 may include any one or a combination of temperature sensors, humidity sensors, hazard-related sensors, other environmental sensors, accelerometers, microphones, optical sensors up to and including cameras (e.g., charged coupled-device or video cameras), active or passive radiation sensors, GPS receivers, and RF identification detectors. In implementations, the wireless network device 700 may include one or more primary sensors as well as one or more secondary sensors, such as primary sensors that sense data central to the core operation of the device (e.g., sensing a temperature in a thermostat or sensing smoke in a smoke detector) while secondary sensors may sense other types of data (e.g., motion, light or sound), which can be used for energy-efficiency objectives or automation objectives.

The wireless network device 700 includes a memory device controller 710 and a memory device 712, such as any type of a nonvolatile memory and/or other suitable electronic data storage device. The wireless network device 700 can also include various firmware and/or software, such as an operating system 714 that is maintained as computer-executable instructions by the memory device 712 and executed by a microprocessor. The device software may also include one or more applications 716 that implement various functionalities of the wireless network device 700. The wireless network device 700 also includes a device interface 718 to interface with another device or peripheral component and includes an integrated data bus 720 that couples the various components of the wireless network device 700 for data communication between the components. The data bus 720 in the wireless network device 700 may also be implemented as any one of or a combination of different bus structures and/or bus architectures.

The device interface 718 may receive input from a user and/or provide information to the user (e.g., as a user interface), and a received input can be used to determine a setting. The device interface 718 may also include mechanical or virtual components that respond to a user input. For example, the user can mechanically move a sliding or rotatable component, or motion along a touchpad may be detected, and such motions may correspond to a setting adjustment of the device 700. Physical and virtual movable user-interface components can allow the user to set a setting along a portion of an apparent continuum. The device interface 718 may also receive inputs from any number of peripherals, such as buttons, a keypad, a switch, a microphone, and an imager (e.g., a camera device).

The wireless network device 700 can include network interfaces 722, such as a home area network interface for communication with other wireless network devices in a home area network, and an external network interface for network communication, such as via the Internet. The wireless network device 700 also includes wireless radio systems 724 for wireless communication with other wireless network devices via the home area network interface and for multiple, different wireless communications systems. The wireless radio systems 724 may include Wi-Fi, Bluetooth™, Mobile Broadband, Bluetooth Low Energy™ (BLE), and/or point-to-point IEEE 702.16.4. Each of the different radio systems can include a radio device, antenna, and chipset that is implemented for a particular wireless communications technology. The wireless network device 700 also includes a power source 726, such as a battery and/or a cable to connect the device 700 to line voltage. An alternating current (AC) power source may also be used to charge the battery of the device 700.

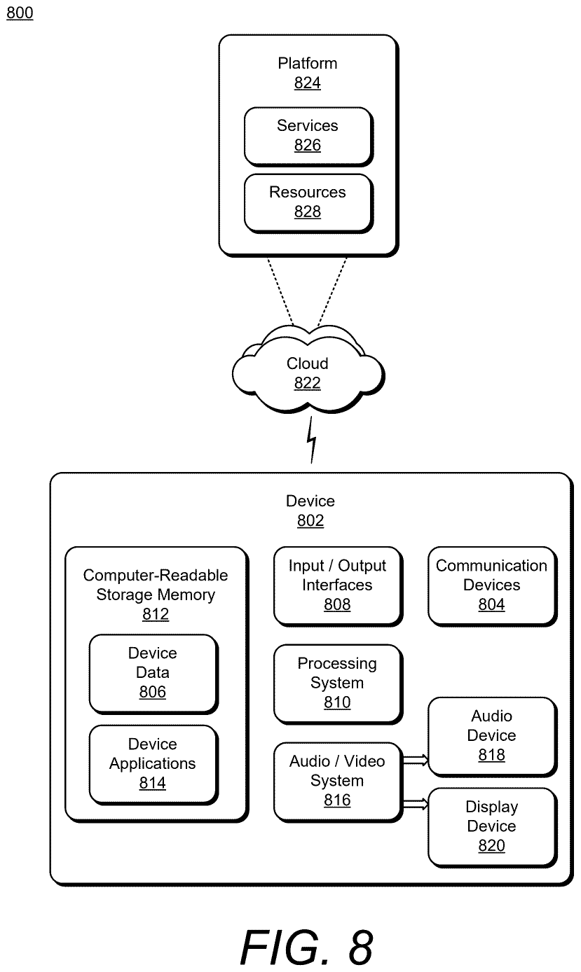

FIG. 8 illustrates an example system 800 that includes an example device 802 that implements aspects of bezel-antenna sharing for a foldable device as described with reference to the previous FIGS. 1 to 7. The example device 802 can be implemented as the wireless network device 700 (in FIG. 7), the foldable electronic device 102 (in FIG. 1), or another device as described herein. The example device 802 may be any type of computing device, client device, mobile phone, tablet, communication device, entertainment device, gaming device, media playback device, and/or another type of device. Further, the example device 802 may be implemented as any other type of wireless network device that is configured for communication over a network, such as a thermostat, hazard detector, camera, lighting unit, commissioning device, router, border router, joiner router, joining device, end device, leader, access point, and/or other wireless network devices.

The device 802 includes communication devices 804 that enable wired and/or wireless communication of device data 806, such as data that is communicated between devices in a home area network, data that is being received, data scheduled for broadcast, data packets of the data, data that is synchronized between the devices, etc. The device data 806 can include any type of communication data, as well as audio, video, and/or image data that is generated by applications executing on the device 802. The communication devices 804 can also include transceivers for cellular phone communication and/or for network data communication.

The device 802 also includes input/output (I/O) interfaces 808, such as data network interfaces that provide connection and/or communication links between the device 802, data networks (e.g., a home area network, external network, etc.), and other devices. The I/O interfaces 808 can be used to couple the device 802 to any type of components, peripherals, and/or accessory devices. The I/O interfaces 808 also include data input ports via which any type of data, media content, and/or inputs can be received, such as user inputs to the device 802, as well as any type of communication data, as well as audio, video, and/or image data received from any content and/or data source.

The device 802 includes a processing system 810 (e.g., integrated circuit(s) 202 that may be implemented at least partially in hardware, such as with any type of microprocessors, controllers, and the like that process executable instructions. The processing system 810 can include components of an integrated circuit, a programmable logic device, a logic device formed using one or more semiconductors, and other implementations in silicon and/or hardware, such as at least one processor and at least one memory system implemented as a system-on-chip (SoC). Alternatively or in addition, the device 802 can be implemented with any one or combination of software, hardware, firmware, or fixed logic circuitry that may be implemented with processing and control circuits. The device 802 may further include any type of a system bus or other data and command transfer system that couples the various components within the device 802. A system bus can include any one or combination of different bus structures and architectures, as well as control and data lines.

The device 802 also includes computer-readable storage memory 812 (e.g., CRM 204), such as data storage devices that can be accessed by a computing device and that provide persistent storage of data and executable instructions (e.g., software applications, modules, programs, functions, and the like). The computer-readable storage memory 812 described herein excludes propagating signals. Examples of computer-readable storage memory 812 include volatile memory and non-volatile memory, fixed and removable media devices, and any suitable memory device or electronic data storage that maintains data for computing device access. The computer-readable storage memory 812 can include various implementations of random access memory (RAM), read-only memory (ROM), flash memory, erasable programmable read-only memory (EPROM), electrically erasable programmable read-only memory (EEPROM), and other types of storage memory in various memory device modes.

The computer-readable storage memory 812 provides storage of the device data 806 and various device applications 814 (e.g., applications 716), such as an operating system (e.g., operating system 206) that is maintained as a software application with the computer-readable storage memory 812 and executed by the processing system 810. The device applications 814 may also include a device manager, such as any form of a control application, a software application, a signal processing and control module, code that is native to a particular device, a hardware abstraction layer for a particular device, and so on.

The device 802 also includes an audio and/or video system 816 that generates audio data for an audio device 818 and/or generates display data for a display device 820 (e.g., display 106). The audio device 818 and/or the display device 820 include any devices that process, display, and/or otherwise render audio, video, display, and/or image data, such as the image content of a digital photo. In implementations, the audio device 818 and/or the display device 820 are integrated components of the example device 802. Alternatively, the audio device 818 and/or the display device 820 are external, peripheral components to the example device 802. In aspects, at least part of the techniques described for bezel-antenna sharing for a foldable device may be implemented in a distributed system, such as over a “cloud” 822 in a platform 824. The cloud 822 includes and/or is representative of the platform 824 for services 826 and/or resources 828.

The platform 824 abstracts underlying functionality of hardware, such as server devices (e.g., included in the services 826) and/or software resources (e.g., included as the resources 828), and connects the example device 802 with other devices, servers, etc. The resources 828 may also include applications and/or data that can be utilized while computer processing is executed on servers that are remote from the example device 802. Additionally, the services 826 and/or the resources 828 may facilitate subscriber network services, such as over the Internet, a cellular network, or a Wi-Fi network. The platform 824 may also serve to abstract and scale resources to service a demand for the resources 828 that are implemented via the platform 824, such as in an interconnected device aspect with functionality distributed throughout the system 800. For example, the functionality may be implemented in part at the example device 802 as well as via the platform 824 that abstracts the functionality of the cloud 822.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although aspects of bezel-antenna sharing for a foldable device have been described in language specific to features and/or methods, the subject of the appended claims is not necessarily limited to the specific features or methods described. Rather, the specific features and methods are disclosed as example implementations of the techniques for bezel-antenna sharing for a foldable device, and other equivalent features and methods are intended to be within the scope of the appended claims. Further, various different aspects are described, and it is to be appreciated that each described aspect can be implemented independently or in connection with one or more other described aspects.

What is claimed is:

1. A foldable electronic device comprising:
a housing having a first housing member and a second housing member connected together by a bendable region, at least one of the first housing member or the second housing member being rotatable about the bendable region, the first housing member having opposing first and second surfaces, the second housing member having opposing third and fourth surfaces, the housing having:
an open mode in which the first and third surfaces are substantially coplanar and the bendable region is between the first and third surfaces; and
a closed mode in which the housing is folded about the bendable region such that the first and third surfaces are substantially parallel to one another and located on a same side of the bendable region;
one or more displays disposed on one or more of the first housing member or the second housing member;
a plurality of antennas integrated with a first bezel of the first housing member;
a plurality of detune elements integrated with a second bezel of the second housing member, the plurality of detune elements configured to detune the plurality of antennas when the housing is in the closed mode; and
a near-field communication (NFC) loop integrated with one or more detune elements of the plurality of detune elements on the second bezel of the second housing member.

2. The foldable electronic device of claim 1, wherein the one or more detune elements include two or more detune elements, and wherein the two or more detune elements are combined to form the NFC loop.

3. The foldable electronic device of claim 2, further comprising a printed circuit board located within the second housing member, wherein the two or more detune elements are bridged together via a non-grounding portion of the printed circuit board.

4. The foldable electronic device of claim 3, wherein the two or more detune elements are electrically connected to the non-grounding portion of the printed circuit board based on surface-mount technology (SMT) springs.

5. The foldable electronic device of claim 1, wherein:
the foldable electronic device is a foldable smartphone; and
the one or more antennas are configured as cellular antennas, WiFi antennas, global navigation satellite system (GNSS) antennas, non-terrestrial network (NTN) antennas, or ultrawide band (UWB) antennas.

6. The foldable electronic device of claim 1, further comprising a circuit configured to diplex NFC signals from radiofrequency (RF) signals, the RF signals including one or more of cellular signals, WiFi signals, global navigation satellite system (GNSS) signals, non-terrestrial network (NTN) signals, and ultrawide band (UWB) signals.

7. The foldable electronic device of claim 6, wherein the circuit includes a diplexer with a total inductance below a first threshold value.

8. The foldable electronic device of claim 7, wherein the first threshold value is approximately 50 nanohenry.

9. The foldable electronic device of claim 6, wherein the circuit includes a diplexer with resistive parasitics below a second threshold value.

10. The foldable electronic device of claim 9, wherein the second threshold value is approximately 1.0 Ohm.

11. The foldable electronic device of claim 6, further comprising a physical shorting structure configured to provide a zero Ohm or an inductive loading on an NFC-grounding port of the one or more detune elements of the second housing member.

12. The foldable electronic device of claim 1, wherein:
the housing includes a length along a y-axis, a width along an x-axis, and a depth along a z-axis;
the length is greater than the width and the width is greater than the depth;
the bendable region is aligned with the y-axis;
the one or more antennas are on an opposing side of the y-axis from the one or more detune elements when the housing is in the open mode; and
the one or more antennas are proximate to the one or more detune elements on a same side of the y-axis when the housing is in the closed mode.

13. The foldable electronic device of claim 1, wherein:
the housing includes a length along a y-axis, a width along an x-axis, and a depth along a z-axis;
the length is greater than the width and the width is greater than the depth;
the bendable region is aligned with the x-axis;
the one or more antennas are on an opposing side of the x-axis from the one or more detune elements when the housing is in the open mode; and
the one or more antennas are proximate to the one or more detune elements on a same side of the x-axis when the housing is in the closed mode.

14. A diplexer circuit for bezel-antenna sharing in a foldable electronic device, the diplexer circuit comprising:
a ground-loading structure configured to load a first detune element of the foldable electronic device to electrical ground, the first detune element located on a bezel of a flip side of the foldable electronic device, the flip side being connected to a base side of the foldable electronic device by a bendable region, the flip side being rotatable about the bendable region relative to the base side;
a first detune circuit connected to the first detune element, the first detune circuit configured to detune a first antenna located on the base side of the foldable electronic device when the foldable electronic device is folded in a closed mode;
a semi-shorting structure electrically connecting the first detune element to a second detune element of the foldable electronic device, the semi-shorting structure configured to for appropriate loading at a first frequency band and have minimal impact at a second frequency band, the second detune element located on the flip side of the foldable electronic device;
a second detune circuit having a series capacitor and being connected to the second detune element, the second detune circuit configured to detune a second antenna on the base side of the foldable electronic device when the foldable electronic device is folded in the closed mode; and
a discreet inductor connected in parallel to the second detune circuit, the discreet inductor configured to isolate a feed matching network for the second frequency band from the second detune element.

15. The diplexer circuit of claim 14, wherein:
the first detune element and the second detune element are each integrated in a bezel of the foldable electronic device.

16. The diplexer circuit of claim 14, wherein the second detune circuit includes:
an LC circuit configured for resonant loading; and
a band pass filter configured to short out-of-band signals to the electrical ground and pass a band of interest with a different loading condition from a loading condition of the LC circuit.

17. The diplexer circuit of claim 14, comprising:
a total inductance of less than 50 nanohenry (nH), wherein the semi-shorting structure has an inductance of less than 20 nanohenry (nH); and
a total parasitic resistance between zero Ohm and 1.0 Ohm.

18. The diplexer circuit of claim 14, wherein:
the ground-loading structure has a zero Ohm or an inductive loading; and
the electrical ground is a hinge of the foldable electronic device.

19. The diplexer circuit of claim 14, wherein:
the first detune element includes a first leg that extends to a printed circuit board of the foldable electronic device;
the second detune element includes a second leg that extends to the printed circuit board; and
the semi-shorting structure is located on the printed circuit board and electrically connects the first leg of the first detune element to the second leg of the second detune element.

20. The diplexer circuit of claim 14, wherein:
the second frequency band corresponds to near-field communication (NFC); and
the ground-loading structure is configured to provide a zero Ohm or an inductive loading on an NFC-grounding port of the first detune element.
